(19) United States
(12) Patent Application Publication
(10) Pub. No.: US 2026/0369150 A1
(43) Pub. Date: Nov. 19, 2026

(54) TRACKING CHILDREN BY MEANS OF A CICO OR BIBO SYSTEM

(71) Applicant: ZF Friedrichshafen AG, Friedrichshafen (DE)

(72) Inventors: Daniel WOLF, Friedrichshafen (DE); Sophia MOCHAR, Villingen-Schwenningen (DE)

(73) Assignee: ZF Friedrichshafen AG, Friedrichshafen (DE)

(21) Appl. No.: 19/158,718

(22) PCT Filed: Jan. 22, 2024
(86) PCT No.: PCT/EP2024/051359

§ 371 Date: Aug. 21, 2025

(30) Foreign Application Priority Data
Feb. 22, 2023 (DE) 10 2023 201 555.2

(51) Int. Cl. G08B 21/02

(52) U.S. Cl. CPC G08B 21/0269

(57) ABSTRACT

A ticket registration system (101) for a passenger transport means (111) includes an interface for the exchange of data with a terminal device (105), such that the ticket registration system (101) is designed to register at least one ticket when the at least one ticket is brought into the passenger transport means (111) or taken out of the passenger transport means (111). The ticket registration system (101) is designed to register locations at which the at least one ticket is brought into the passenger transport means (111) or taken out of the passenger transport means (111), and/or the associated times, and to transmit them to the terminal device (105).

### RELATED APPLICATIONS

This application claims the benefit under 35 U.S.C. § 371 as a U.S. National Phase Application of application no. PCT/EP2024/051359, filed on 22 Jan. 2024, which claims the benefit of German Patent Application no. 10 2023 201 555.2 filed on 22 Feb. 2023, the contents of which are hereby incorporated herein by reference in their entireties.

### FIELD OF THE DISCLOSURE

The invention relates to a ticket registration system, a passenger transport means, a terminal device, and a method for tracking a ticket.

### BACKGROUND

GPS-based location devices for children are known from the prior art. Thus, children can be monitored in order to protect them from possible dangers. However, to recognize the risks, very close monitoring is necessary. For data-protection reasons this is problematic and also ties up time resources.

### SUMMARY

The purpose of the present invention is to improve the monitoring of vulnerable people, in particular children. This objective is achieved by a ticket registration system, a passenger transport means, a terminal device, and a method of tracking a ticket as disclosed herein. Preferred further developments emerge from the present disclosure.

The ticket registration system according to the invention is designed for use in or on a passenger transport means. In particular the ticket registration system can be part of the passenger transport means and can correspondingly be incorporated into the passenger transport means.

In general terms, a passenger transport means a means for transporting people. In particular it can be a railroad vehicle or a road vehicle, for example a train or a bus.

The ticket registration system comprises an interface for the exchange of data with a terminal device. The data can be exchanged by way of a direct or an indirect path. In an exchange via a direct path a data transmission connection between the interface of the ticket registration system and a corresponding interface of the terminal device can be provided.

A terminal device denotes a computer device provided for use by a user. For example, the terminal device can be provided for use by a legal guardian of a child to be monitored. Preferably, it is a mobile terminal device such as a Smartphone.

In the case of an indirect transmission there is a central computer between the ticket registration system and the terminal device. Data transmission connections are formed both between the interface of the ticket registration system and a corresponding interface of the central computer, and also between a further interface of the central computer and the interface of the terminal device. The data to be exchanged are transmitted from the ticket registration system to the central computer and from the central computer to the terminal device, or from the terminal device to the central computer and from there to the ticket registration system.

A central computer is a computer which is installed at a fixed location. It is designed to exchange data via one or more interfaces with other computers, for example in terminal devices.

The ticket registration system is designed to register tickets when the tickets are taken into the passenger transport means or taken out of the passenger transport means, for example when people with a ticket enter or leave the passenger transport means, or when the passenger transport means is loaded or unloaded with baggage that is provided with a ticket. Animals to be transported can also be provided with a ticket, which is correspondingly registered.

In the context of the present invention all forms of ticket are possible. For example, they can be paper tickets which are read by a scanner fitted in the passenger transport means. They can also be electronic tickets which transmit data for the registration of the ticket by wireless means to a receiver device fitted in the passenger transport means.

As electronic tickets, for example mobile terminal devices are suitable, which transmit ticket data via Bluetooth. Likewise, BLE tags or RFID or NFC chips together with corresponding detection devices fitted into the passenger transport means can be used as tickets.

According to the invention, the ticket registration system is designed to register locations at which a ticket is brought into or taken out of the passenger transport means, and/or the associated times. An associated time means the time when the ticket is brought into or taken out of the passenger transport means. As the location, preferably that location is registered where the passenger transport means is when the ticket is brought into or taken out of the passenger transport means.

The data registered and/or the associated times are transmitted to the terminal device. As described earlier, the transmission can take place directly or indirectly.

In detail, data for the identification of the location concerned and/or the associated time are transmitted. The data can be GPS coordinates of the passenger transport means or information about where it has stopped while the ticket is being brought into or taken out of the passenger transport means.

The passenger transport means with the ticket registration system corresponds to a further aspect of the invention.

Another aspect of the invention also corresponds to the above-described terminal device. This comprises an interface for the exchange of data with the above-described ticket registration system. By way of the interface, the data can be exchanged directly or indirectly, as described above.

According to the invention, the terminal device is designed, via its interface, to receive locations or data for identifying locations at which a ticket is brought into or taken out of the passenger transport means, and/or the associated times or data for identifying those times. The data received are the data described above and transmitted by the ticket registration system.

When a vulnerable person enters and leaves the passenger transport means, these are safety-critical events. The invention enables those events to be monitored and tracked in a targeted manner when the vulnerable person is carrying a ticket.

A corresponding method according to the invention serves to track the ticket and therefore the vulnerable person. The method provides means for establishing a nominal travel route by data on one or more locations where the ticket has been taken into or taken out of the passenger transport means, and/or data on the associated times. The nominal travel route corresponds to the totality of the locations indicated and, if necessary, the associated times.

An actual travel route is registered by means of the ticket registration system as described above. Thus, by means of the ticket registration system, locations where the ticket has been brought into or taken out of the passenger transport means and/or the associated times are registered.

Finally, the nominal travel route is compared with the actual travel route. For that purpose, the locations established and, if necessary, the associated times are compared with the locations registered and, if necessary, the associated times.

In a preferred further development, deviations of the actual travel route from the nominal travel route are determined by virtue of the comparison according to the invention.

Slight deviations of the actual travel route from the nominal travel route, for example due to delays of the passenger transport means, can be tolerated. However, larger deviations are alarming. Accordingly, in a preferred further development, a notification or alarm is emitted if at least one deviation does not satisfy a predetermined criterion. As the criterion, for example, an upper limit for the spatial deviation and/or an upper limit for the time deviation are suitable.

In a preferred further development, the nominal travel route is established by means of a terminal device. In particular, the terminal device described can be that described above. In detail, the above-described locations and, if necessary, the associated times by which the nominal travel route is defined are entered by way of input means of the terminal device.

In a preferred further development, the nominal travel route is compared with the actual travel route by a terminal device or a central computer. In particular, the terminal device can be the terminal device described above and the central computer can be the central computer described above. If the nominal travel route has been established by the terminal device and the comparison is carried out by the central computer, then the nominal travel route, or data that define the corresponding locations and, if necessary, the associated times, are transmitted in advance by the terminal device to the central computer.

### BRIEF DESCRIPTION OF THE DRAWING

A preferred example embodiment of the invention is illustrated in the sole figure, FIG. 1. In detail, the sole figure shows:

FIG. 1: A system for tracking people.

### DETAILED DESCRIPTION

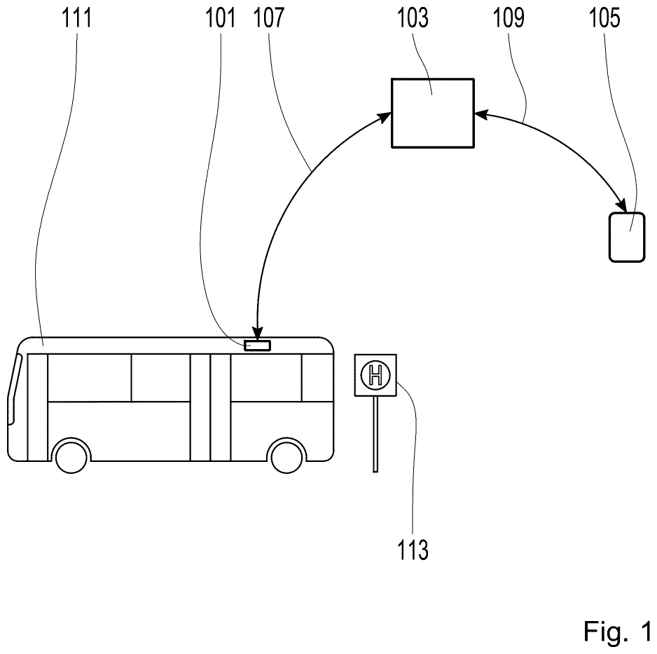

FIG. 1 shows a ticket registration system 101 with a central computer 103 and a mobile terminal device 105. The ticket registration system 101 is connected to the central computer 103 by a first data connection 107. In turn, the computer is connected to the mobile terminal device 105 by a second data connection 109.

The ticket registration system serves to register tickets held by people in a bus 111. Accordingly, the ticket registration system 101 is installed in the bus 111. Moreover, the ticket registration system 101 is designed to register the location of the bus 111, for example a bus-stop where the bus 111 has stopped.

The data registered, namely the data about tickets of people boarding or leaving the bus 111, along with data on the location of the bus 111 or the bus-stop 113 concerned, are transmitted by the ticket registration system 101 to the central computer 103 via the first data connection 107. From the data transmitted the central computer 103 generates actual travel routes of the people concerned. Furthermore, nominal travel routes of vulnerable people are stored in the central computer 103. The computer compares these with the respective actual travel routes. If an unacceptable deviation is found, then the central computer emits a warning message to the terminal device 105 via the second data connection 109.

### INDEXES

101 Ticket registration system
103 Central computer
105 Terminal device
107 Data connection
109 Data connection
111 Bus
113 Bus-stop

1. A terminal device (105) comprising:
an interface for the exchange of data with a ticket registration system (101) for a passenger transport means (111);
an interface for the exchange of data with a terminal device (105);
wherein the ticket registration system (101) is configured to register at least one ticket when the at least one ticket is bought into the passenger transport means (111) or taken out of the passenger transport means (111);
wherein the ticket registration system (101) is configured to register locations at which the at least one ticket is bought into the passenger transport means (111) or taken out of the passenger transport means (111) and/or the associated times and to transmit them to the terminal device (105);
wherein the terminal device (105) is configured to receive by way of its interface locations at which the at least one ticket is bought into the passenger transport means (111) or taken out of the passenger transport means (111) and/or the associated times; and
wherein the terminal device is configured to compare a nominal travel route with the actual travel route by comparing the specified locations and/or associated times with the locations and/or associated times registered.

2. A method for tracking a ticket, the method comprising:
establishing a nominal travel route by means of information about one or more locations at which the ticket is bought into a passenger transport means (111) or taken out of the passenger transport means (111), and/or the associated times,
registering an actual travel route by determining locations at which the ticket is bought into a passenger transport means (111) or taken out of the passenger transport means (111), and/or the associated times, by means of a ticket registration system (101) for a passenger transport means (111) having an interface for the exchange of data with a terminal device (105), when the at least one ticket is bought into the passenger transport means (111) or taken out of the passenger transport means (111) wherein the ticket registration system (101) is configured to register locations at which the at least one ticket is bought into the passenger transport means (111) or taken out of the passenger transport means (111) and/or the associated times, and to transmit them to the terminal device (105); wherein the terminal device (105) configured, via its interface, to receive locations at which the at least one ticket is bought into the passenger transport means (111) or taken out of the passenger transport means (111) and/or the associated times; and
comparing the nominal travel route with the actual travel route by comparing the specified locations and/or associated times with the detected locations and/or associated times by means of the terminal device (105) or by means of a central computer (103).

3. The method according to claim 2, comprising determining deviations of the actual travel route from the nominal travel route.

4. The method according to claim 3, comprising:
determining that at least one of the deviations does not satisfy a predetermined criterion; and
emitting a notification or an alarm.

5. The method according to claim 1, wherein the nominal travel route is established by means of a terminal device (105).
